(19) United States
(12) Patent Application Publication
(10) Pub. No.: US 2016/0084100 A1
(43) Pub. Date: Mar. 24, 2016

(54) SYSTEM AND APPARATUS FOR SEAL RETENTION AND PROTECTION

(71) Applicant: United Technologies Corporation, Hartford, CT (US)

(72) Inventors: Timothy M. Davis, Kennebunk, ME (US); Mark J. Rogers, Kennebunk, ME (US)

(73) Assignee: United Technologies Corporation, Hartford, CT (US)

(21) Appl. No.: 14/951,665

(22) Filed: Nov. 25, 2015

Related U.S. Application Data
(63) Continuation of application No. PCT/US2014/052929, filed on Aug. 27, 2014.
(60) Provisional application No. 61/877,620, filed on Sep. 13, 2013.

(51) Int. Cl. F01D 11/00; F02C 3/04; F01D 25/24; F16J 15/08; F16J 15/06

(52) U.S. Cl. CPC F01D 11/005; F16J 15/0812; F16J 15/064; F01D 25/24; F02C 3/04; F05D 2240/55; F05D 2220/32

(57) ABSTRACT

A sheath and seal assembly for protecting, containing and insulating a seal is provided. The seal may be installable within the sheath forming a seal-sheath assembly. The assembly may be capable of being installed in the hot section of a gas turbine. The sheath may be a woven, braided, and/or chain link structure. The sheath may be capable of allowing pressure to be conducted to a portion of the seal to load the seal against one or more portions of a housing.

### CROSS-REFERENCE TO RELATED APPLICATIONS

This application is a continuation of, claims priority to and the benefit of, PCT/US2014/052929 filed on Aug. 27, 2014 and entitled “SYSTEM AND APPARATUS FOR SEAL RETENTION AND PROTECTION,” which claims priority from U.S. Provisional Application No. 61/877,620 filed on Sep. 13, 2013 and entitled “SYSTEM AND APPARATUS FOR SEAL RETENTION AND PROTECTION.” Both of the aforementioned applications are incorporated herein by reference in their entirety.

### FIELD OF INVENTION

The present disclosure relates to systems and apparatuses for seal protection, and more specifically, to a sheath that is capable of retaining, insulating, and shielding a seal.

### BACKGROUND OF THE INVENTION

Modules of a gas turbine engine may be joined together. Seals may be included within the joints between the modules to minimize leakage. The leakage between certain modules (e.g., hot section modules) and components may introduce thermal loads on the seals that may stress, deform, fracture, and/or degrade the seals over time. The degradation can lead to seal liberation (e.g., a portion and/or portions of the seal may break away from the larger seal), increasing the risk of foreign object damage (“FOD”) or contamination of the surrounding structure. Moreover, seal deformation, degradation, and/or liberation may contribute to loss of performance and/or efficiency of the gas turbine engine and/or degradation of components within the gas turbine.

### SUMMARY OF THE INVENTION

A seal is provided. The assembly may comprise a seal member and a sheath. The sheath may be configured to surround and contain the seal member.

In various embodiments, a gas turbine engine may comprise a hot section, a sheath, and a seal member. The hot section may have a first housing and a second housing. The sheath may be configured to be installed between the first housing and the second housing. The seal member may be installed within the sheath. The seal member may also be capable of being loaded (i.e., thermally and/or mechanically loaded) against the first housing and the second housing to form a sealing interface between the first housing and the second housing.

In various embodiments, a gas turbine hot section may comprise a compressor, a turbine, a combustor, a first housing, a second housing, a seal member and a sheath. The turbine may be operatively associated with the compressor. The combustor may be configured to burn fuel to drive the turbine. The first housing may be configured to enclose a portion of at least one of the compressor, the turbine and the combustor. The second housing may also be configured to enclose a portion of at least one of the compressor, the turbine and the combustor. The sheath may be configured to surround the seal member. The sheath may also be configured to be installed between the first housing and the second housing.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 is a cross-sectional view of a gas turbine engine, in accordance with various embodiments.

FIG. 2A is a side cross-sectional view of a seal-sheath assembly installed between a first engine component and a second engine component, in accordance with various embodiments.

FIG. 2B is a front view of a seal-sheath assembly, in accordance with various embodiments.

FIG. 3A illustrates a portion of a sheath assembly having a braided and/or woven structure, in accordance with various embodiments.

FIG. 3B illustrates a portion of a sheath assembly having a chain link structure, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Different cross-hatching and/or surface shading may be used throughout the figures to denote different parts but not necessarily to denote the same or different materials.

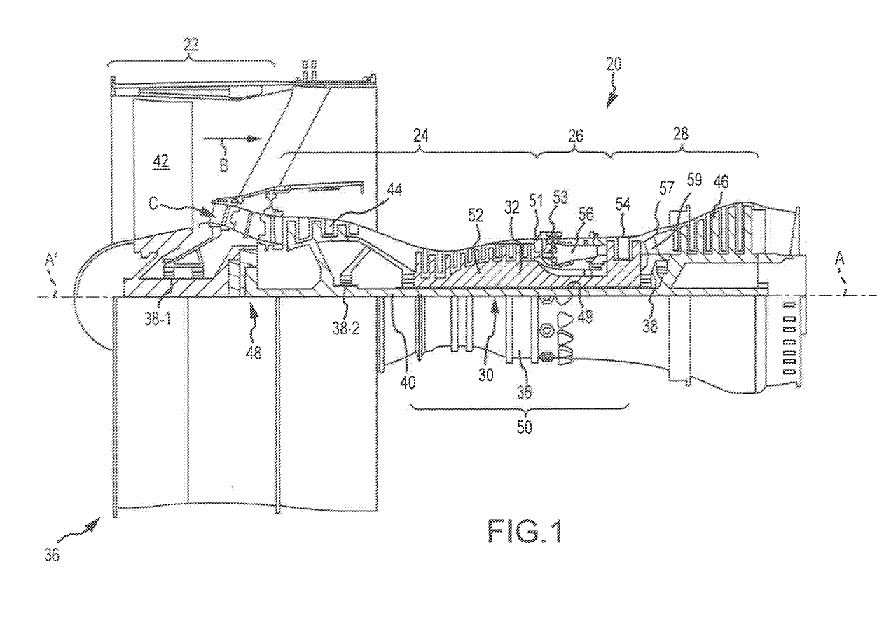

In various embodiments, and with reference to FIG. 1, a gas turbine engine 20 is provided. Gas turbine engine 20 may be a two-spool turbofan that generally incorporates a fan section 22, a compressor section 24, a combustor section 26 and a turbine section 28. Alternative engines may include, for example, an augmentor section among other systems or features. In operation, fan section 22 can drive air along a bypass flow-path B while compressor section 24 can drive air along a core flow-path C for compression and communication into combustor section 26 then expansion through turbine section 28. Although depicted as a turbofan gas turbine engine herein, it should be understood that the concepts described herein are not limited to use with turbofans as the teachings may be applied to other types of turbine engines including three-spool architectures.

Gas turbine engine 20 may generally comprise a low speed spool 30 and a high speed spool 32 mounted for rotation about an engine central longitudinal axis A-A′ relative to an engine static structure 36 via several bearing systems 38, 38-1, and 38-2. It should be understood that various bearing systems at various locations may alternatively or additionally be provided, including for example, bearing system 38, bearing system 38-1, and bearing system 38-2.

Low speed spool 30 may generally comprise an inner shaft 40 that interconnects a fan 42, a low pressure (or first) compressor section 44 and a low pressure (or first) turbine section 46 Inner shaft 40 may be connected to fan 42 through a geared architecture 48 that can drive fan 42 at a lower speed than low speed spool 30. High speed spool 32 may comprise an outer shaft 49 that interconnects a high pressure (or second) compressor section 52 and high pressure (or second) turbine section 54. A combustor 56 may be located between high pressure compressor 52 and high pressure turbine 54. A mid-turbine frame 57 of engine static structure 36 may be located generally between high pressure turbine 54 and low pressure turbine 46. Mid-turbine frame 57 may support one or more bearing systems 38 in turbine section 28 Inner shaft 40 and outer shaft 49 may be concentric and rotate via bearing systems 38 about the engine central longitudinal axis A-A′, which is collinear with their longitudinal axes. As used herein, a “high pressure” compressor or turbine experiences a higher pressure and temperature than a corresponding “low pressure” compressor or turbine. As used herein, a hot section 50 of the engine may comprise high pressure compressor 52, combustor 56, and/or high pressure turbine 54. Various components of hot section 50 may be exposed to temperatures above approximately 1000° F. (approximately 538° C.).

The core airflow C may be compressed by low pressure compressor 44 then high pressure compressor 52, mixed and burned with fuel in combustor 56, then expanded over high pressure turbine 54 and low pressure turbine 46. Mid-turbine frame 57 includes airfoils 59 which are in the core airflow path. Turbines 46, 54 rotationally drive the respective low speed spool 30 and high speed spool 32 in response to the expansion.

Gas turbine engine 20 may be, for example, a high-bypass geared aircraft engine. In various embodiments, the bypass ratio of gas turbine engine 20 may be greater than about six (6). In various other embodiments, the bypass ratio of gas turbine engine 20 may be greater than ten (10). In various embodiments, geared architecture 48 may be an epicyclic gear train, such as a star gear system (sun gear in meshing engagement with a plurality of star gears supported by a carrier and in meshing engagement with a ring gear) or other gear system. Gear architecture 48 may have a gear reduction ratio of greater than about 2.3 and low pressure turbine 46 may have a pressure ratio that is greater than about 5. In various embodiments, the diameter of fan 42 may be significantly larger than that of the low pressure compressor 44, and the low pressure turbine 46 may have a pressure ratio that is greater than about 5:1. Low pressure turbine 46 pressure ratio may be measured prior to inlet of low pressure turbine 46 as related to the pressure at the outlet of low pressure turbine 46 prior to an exhaust nozzle. It should be understood, however, that the above parameters are exemplary of various embodiments of a suitable geared architecture engine and that the present disclosure contemplates other gas turbine engines including direct drive turbofans.

In various embodiments, leakage or secondary flow from the gas path (e.g., leakage associated with core flow C) of hot section 50 of a gas turbine engine 20 may have a negative effect on engine fuel burn, performance, efficiency, and/or life of various components, seals, and/or modules. Hot section 50 of gas turbine engine 20 may be enclosed by one or more housings that surround and/or enclose high pressure compressor 52, combustor 56 and high pressure turbine 54. These housings may be sealed and/or coupled together to enclose the various components of hot section 50 of gas turbine engine 20. During operation, as the heat load on gas turbine engine 20 increases, the overall length of gas turbine engine 20 may increase (e.g., by approximately ½ inch (approximately 1.27 centimeters) to approximately 1 inch (approximately 2.54 centimeters)). This thermal growth may contribute to the leakage through or out of the housings. One or more seals may be installed between the various modules and housing of any components of gas turbine engine 20 (e.g., hot section 50), around an outer diameter of gas turbine engine 20 to reduce and/or minimize the leakage. The seals may be any suitable seal including for example, a “W” seal, a “U” seal, a “C” seal and/or the like. In this regard, the seal may have a cross-sectional shape that is similar to and/or approximates a “W,” a “U,”, and/or a “C.”

In various embodiments, this leakage between the housings of hot section 50 may be of a relatively hot flow. The hot flow may impose a thermal load on the one or more seals. The hot flow may produce heat and/or conductive heat loads, as well as, pressure that may deform and/or deflect the one or more seals. In this regard, the total heat load and/or pressure may stress and/or degrade the seals. Moreover, the elevated temperatures of this leakage from hot section 50 of gas turbine engine 20 may preclude the use of certain types of seals. For example, the seal may be made of materials that are capable of enduring and/or surviving in environments with relatively high temperatures associated with the various thermal loads and/or heat loads from hot section 50. As discussed herein, components in the hot section 50 may be exposed to and/or reach temperature of more than 1000° F. (approximately 538° C.) and components near the combustor may be exposed to and/or reach a temperature of more than 2000° F. (approximately 1093° C.). However, seal materials that are capable of surviving in environments with relatively high temperatures may generally have lower strength properties making the seals more susceptible to permanent deformation, failure, and/or liberation. In accordance with various embodiments of the present disclosure, such seals are housed or installed in a sheath and/or thermal bag in order to minimize these thermal loads on the seal and/or contain any liberation events associated therewith and/or reduce wear of the seal.

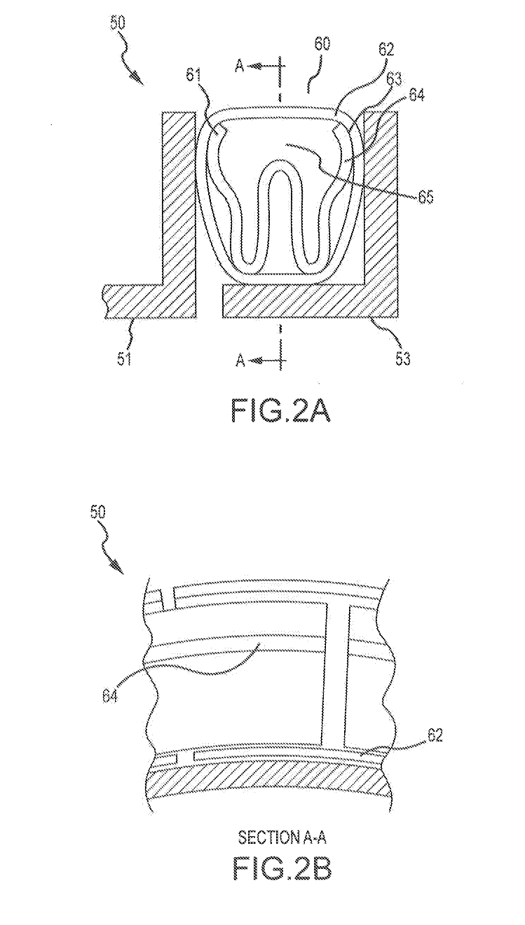

In various embodiments and with reference to FIGS. 1 and 2A-2B, a seal 64 (e.g., a seal member) may be installed and/or housed in a sheath 62 (e.g., a thermal bag) to form a seal 60 (also referred to herein as a seal-sheath assembly 60) that may be installed in and/or between one or more housings (e.g., housing 51 and housing 53) in hot section 50 of gas turbine engine 20, as shown in FIGS. 1 and 2A. Seal-sheath assembly 60 may be installed about in a chamber defined about a diameter (e.g., around a full hoop) of gas turbine engine 20 circumference.

In various embodiments, seal 64 and sheath 62 may be installed about an outer diameter of gas turbine engine 20. In this regard, sheath 62 may insulate and/or shield seal 64 from heat and/or thermal loads at any point about the diameter of gas turbine engine 20. Moreover, sheath 62 may contain and/or trap seal 64 and/or portions of seal 64 if seal 64 fractures. Sheath 62 may additionally or alternatively provide sufficient fluid communication between the secondary flow (e.g., the flow from the compressor sections of gas turbine 20 that flows around combustor 56) of hot section 50 of gas turbine engine 20 and seal 64, such that, seal 64 is pressurized from the pressure associated with the secondary flow of hot section 50 of gas turbine engine 20. In this regard, a region 65 (e.g., a volume) between the leg 61 and leg 63 of seal 64 may be pressurized, causing the leg 61 and leg 63 of 64 to be deflected and/or push against one or more sections, modules, and/or housings (e.g., housing 51 and housing 53) of gas turbine engine 20, as shown in FIGS. 1 and 2A. In this regard, the each of leg 61 and leg 63 may contact each or housing 51 and housing 53 respectively. Moreover, legs 61 and 63 may exert and/or compress sheath 62 against housings 51 and/or 53.

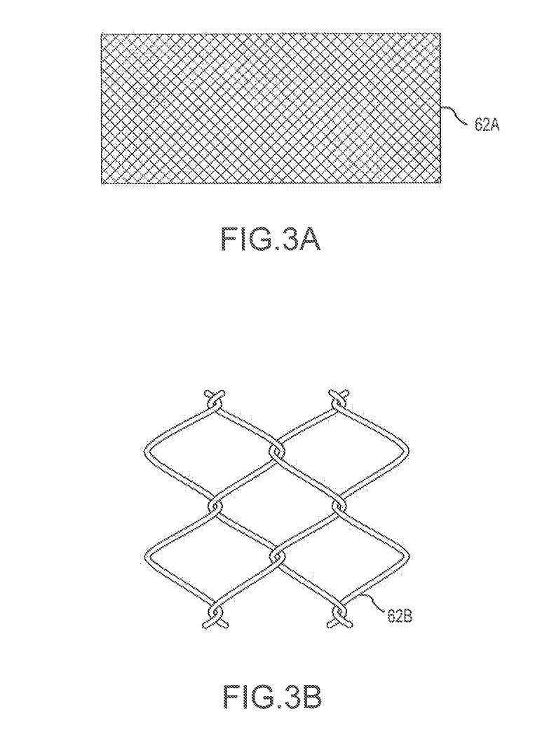

In various embodiments, and with reference to FIGS. 2A-2B and 3A-3B, sheath 62 may be any suitable structure. For example, sheath 62 may be a woven, braided (e.g., sheath 62A), and/or chain-link structure (e.g., sheath 62B). In various embodiments, sheath 62 may also be any suitable material for the thermal environments typically encountered in hot section 50, including for example a metallic and/or non-metallic material. In this regard, it will be appreciated that sheath 62 provides sufficient flexibility to allow seal 64 to seal and/or contact one or more walls and/or structures of housing 51 and/or housing 53 in hot section 50 of gas turbine engine 20. Moreover, sheath 62 may allow sufficient pressure to be conducted and/or transmitted to region 65 of seal 64 in order to load seal 64 against one or more walls of the various structures of hot section 50 of the gas turbine.

In various embodiments, sheath 62 may be configured to provide improved wear characteristics. In this regard, the material of sheath 62 may be chosen such that wear between sheath 62 and seal 64 does not degrade seal 64.

In various embodiments, sheath 62 may also provide and/or minimize thermal load on seal 64. Sheath 62 may be configured to insulate seal 64 from the radiant, conductive, and/or convective heat load from hot section 50 of the gas path of gas turbine engine 20. Moreover, sheath 62 may be configured to create a barrier, separate, and/or reduce contact between seal 64 and one or more engines components in hot section 50. In this regard, the reduced contact between seal member 64 and one or more walls of the housing(s) of hot section 50 may reduce the overall conductive thermal and/or heat lead on seal 64. The gap created by sheath 62 between the one or more engine components and seal 64 may also provide a flow path and/or leakage path that may provide additional cooling flow. As such, seal 64 may be capable of being made from a material with a higher strength, greater flexibility, and relatively lower temperature capability.

In various embodiments, sheath 62 may enable use in a higher temperature environments relative to a high strength metallic seal such as seal 64 which may permit the use of seal-sheath assembly 60 in hot section 50 locations such as near the combustor 56 and/or high pressure turbine 54 where the temperature of the surrounding structure and/or gas may be greater than approximately 2000° F. (approximately 1093° C.).

In various embodiments, sheath 62 may prevent liberation of one or more pieces of seal 64. Liberation may occur in response to seal 64 being cyclically deflected by one or more forward and/or aft components of hot section 50, causing low cycle fatigue, which may cause portions of seal 64 to degrade and/or detach from the structure of seal 64. Liberation may further be minimized by improving the wear characteristics of seal-sheath assembly 60.

In various embodiments, seal-sheath assembly 60 may have improved high cycle fatigue life as compared to an installation of only a seal such as, for example, a W seal. In this regard, sheath 62 may provide dampening associated with a braided, woven, and/or similarly multi-strand construction. In this regard, sheath 62 may be a composite structure that is formed from strands or sheets of a thermally tolerant material, such as a, thermal fabric and/or any other suitable material.

In various embodiments, the braided, woven, and/or multi-strand construction of sheath 62 (e.g., sheath 62A, as shown in FIG. 3A) may provide a designed density for sheath 62. In this regard, the density may be designed to produce a desired metered flow and/or leakage to and/or through region 65 and/or seal 64.

In various embodiments, sheath 62 may be made of any suitable high temperature material. Sheath 62 may be a metal, metal alloy, non-metallic composite material and/or the like. Similarly, seal 64 may be made of any suitable high temperature material that is capable of withstanding and/or surviving the fatigue loading associated with hot section 50.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A seal, comprising:
a seal member; and
a sheath configured to surround and contain the seal member.

2. The seal of claim 1, wherein the seal member has a cross-sectional profile that is substantially shaped as at least one of a “W”, a “U”, and a “C”.

3. The seal of claim 1, wherein the sheath has at least one of a woven structure and a braided structure.

4. The seal of claim 1, wherein the sheath has a chain link structure.

5. The seal of claim 1, wherein a pressure is transmitted through the sheath to load the seal member.

6. The seal of claim 1, wherein the seal is configured to be installed between a first module and a second module in a gas turbine engine within a hot section of the gas turbine engine.

7. The seal of claim 1, wherein the sheath fully encapsulates the seal member.

8. The seal of claim 1, wherein the sheath is configured to thermally insulate the seal member.

9. A gas turbine engine, comprising:
a hot section having a first housing and a second housing;
a sheath configured to be installed between the first housing and the second housing; and
a seal member installed within the sheath and capable of being mechanically loaded against the first housing and the second housing to form a sealing interface between the first housing and the second housing.

10. The gas turbine of claim 9, wherein the hot section includes a compressor, a combustor, and a turbine.

11. The gas turbine of claim 9, wherein sheath is made of at least one of a woven structure and a braided structure.

12. The gas turbine of claim 11, wherein the seal defines an internal pressurizable region.

13. The gas turbine of claim 12, wherein the sheath is configured to conduct pressure from the hot section to the pressurizable region to the seal to mechanically load the seal against the first housing and the second housing.

14. The gas turbine of claim 9, wherein the first housing is exposed to temperatures of greater than 1000° F. (approximately 538° C.) and the second housing is exposed to temperatures greater than 2000° F. (approximately 1093° C.).

15. The gas turbine of claim 9, wherein the sheath is configured to contain at least a portion of the seal member within the sheath in response to a liberation event, wherein the at least a portion of the seal member breaks away from the seal member.

16. The gas turbine of claim 9, wherein the seal has a cross-sectional profile that is shaped as one of a “W”, a “U”, and a “C”.

17. A gas turbine hot section, comprising:
a compressor;
a turbine operatively associated with the compressor;
a combustor configured to burn fuel to drive the turbine;
a first housing configured to enclose a portion of at least one of the compressor, the turbine and the combustor;
a second housing configured to enclose a portion of at least one of the compressor, the turbine and the combustor;
a seal member; and
a sheath configured to surround the seal, the sheath configured to be installed between the first housing and the second housing.

18. The gas turbine hot section of claim 17, wherein the sheath is configured to thermally insulate and contain the seal member.

19. The gas turbine hot section of claim 17, wherein the sheath has at least one of a braided structure, a woven structure, and a chain link structure.

20. The gas turbine hot section of claim 17, wherein the sheath is configured to conduct pressure from the hot section to the seal member to mechanically load the seal member against the first housing and the second housing to form respective sealing interfaces between the seal member and the first and second housings.
